(19) United States
(12) Patent Application Publication
(10) Pub. No.: US 2016/0174662 A1
(43) Pub. Date: Jun. 23, 2016

(54) PENCIL SHARPENING FOOTWEAR DEVICE

(71) Applicant: Maritza H. Broche, Tampa, FL (US)

(72) Inventor: Maritza H. Broche, Tampa, FL (US)

(21) Appl. No.: 14/575,169

(22) Filed: Dec. 18, 2014

(51) Int. Cl. A43C 19/00; B43L 19/00; B43L 23/08; A43B 13/14

(52) U.S. Cl. CPC A43C 19/00; A43B 13/14; B43L 19/0056; B43L 23/08

(57) ABSTRACT

A pencil sharpening footwear device facilitates availability of a pencil sharpener for a user. The device includes a sole coupled to an upper defining a shoe configured for wearing on a human foot. The sole has a pair of lateral sides extending between a front of the sole and a back of the sole. The sole is structured to include a channel extending through the sole between the lateral sides. A housing is insertable into the channel. The housing is structured to include a conical receiver and a slot extending along the conical receiver. A blade is coupled to the housing extending along the slot in the conical receiver to sharpen a pencil inserted into the conical receiver.

### BACKGROUND OF THE DISCLOSURE

### Field of the Disclosure

The disclosure relates to footwear devices and more particularly pertains to a new footwear device for facilitating availability of a pencil sharpener for a user.

### SUMMARY OF THE DISCLOSURE

An embodiment of the disclosure meets the needs presented above by generally comprising a sole coupled to an upper defining a shoe configured for wearing on a human foot. The sole has a pair of lateral sides extending between a front of the sole and a back of the sole. The sole is structured to include a channel extending through the sole between the lateral sides. A housing is insertable into the channel. The housing is structured to include a conical receiver and a slot extending along the conical receiver. A blade is coupled to the housing extending along the slot in the conical receiver to sharpen a pencil inserted into the conical receiver.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top front side perspective view of a pencil sharpening footwear device according to an embodiment of the disclosure.

FIG. 2 is a side view of an embodiment of the disclosure.

FIG. 3 is a side view of an embodiment of the disclosure.

FIG. 4 is a partially exploded top view of an embodiment of the disclosure.

FIG. 5 is a bottom view of an embodiment of the disclosure.

### DESCRIPTION OF THE PREFERRED EMBODIMENT

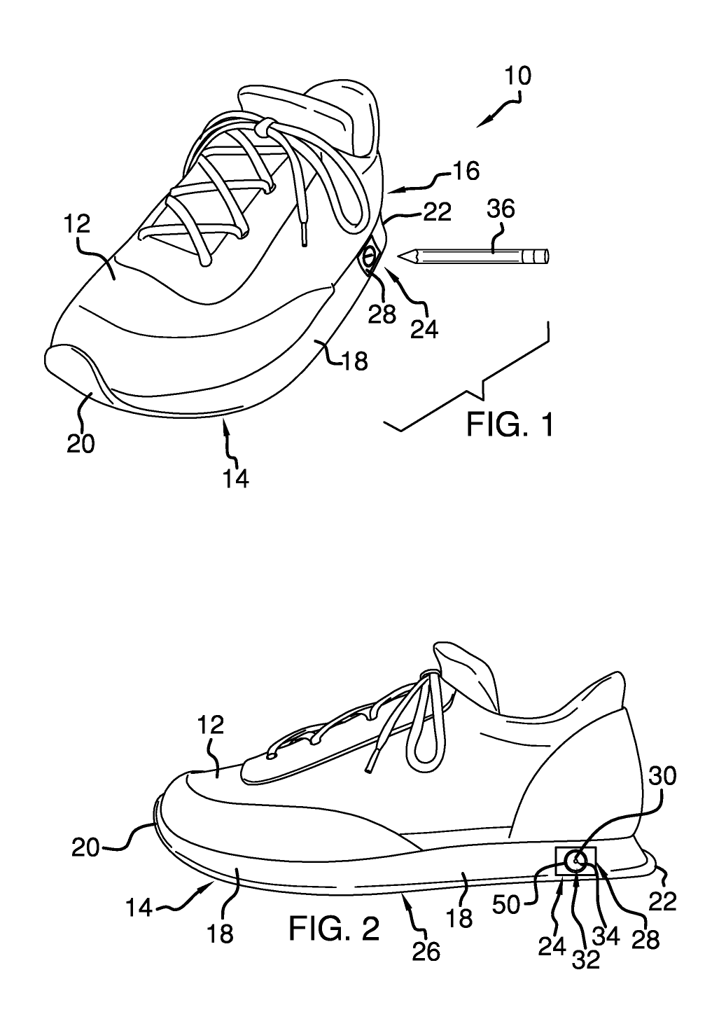

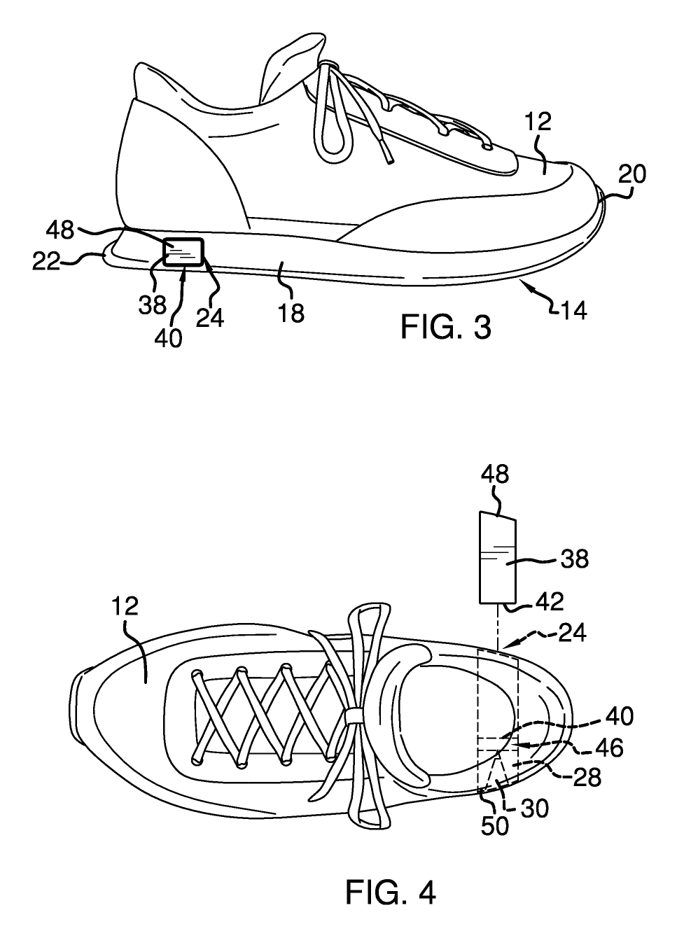

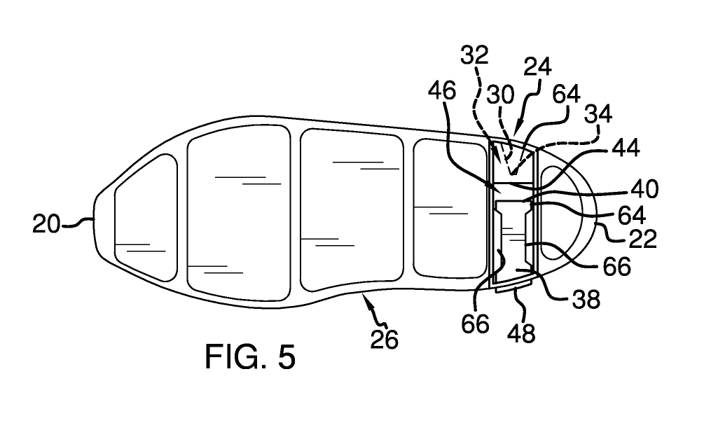

With reference now to the drawings, and in particular to FIGS. 1 through 5 thereof, a new footwear device embodying the principles and concepts of an embodiment of the disclosure and generally designated by the reference numeral 10 will be described.

As best illustrated in FIGS. 1 through 5, the pencil sharpening footwear device 10 generally comprises an upper 12 of conventional design and a sole 14 coupled to the upper 12. The upper 12 and the sole 14 define a shoe 16 configured for wearing on a human foot. The sole 14 has a pair of lateral sides 18 extending between a front 20 of the sole 14 and a back 22 of the sole 14. The sole 14 is structured to include a channel 24 extending through the sole 14 between the lateral sides 18. The channel 24 is positioned between a middle 26 of the sole 14 and the back 22 of the sole 14 wherein the channel 24 is configured to be positioned under a heel of the human foot inserted into the shoe 16. A bottom of the channel 24 may be open.

A housing 28 is insertable into the channel 24. A peripheral lip 64 may extend around the bottom of the channel 24 to prevent the housing 28 from exiting the channel 24 through the bottom of the sole 14. The housing 28 is structured to include a conical receiver 30 and a slot 32 extending along the conical receiver 30. A blade 34 is coupled to the housing 28. The blade 34 extends along the slot 32 in the conical receiver 30 wherein the blade 34 is configured to sharpen a pencil 36 inserted into the conical receiver 30 and rotated.

An eraser 38 is insertable into the channel 24. The eraser 38 has an outer peripheral shape 40 complementary to the channel 24 such that the eraser 38 is retained within the channel 24 when the eraser 38 is inserted into the channel 24. A pair of flanges 66 may extend from the peripheral lip 64 to facilitate retention of the eraser 38 in the channel 24. A proximal surface 42 of the eraser 38 relative to the housing 28 is positioned in spaced relationship to an innermost edge 44 of the housing 28 when the housing 28 and the eraser 38 are both positioned fully within the channel 24. Thus, a space 46 between the eraser 38 and the housing 28 is configured for insertion of a finger to facilitate removal of the housing 28 and the eraser 38 from the channel 24. An exposed surface 48 of the eraser 38 is flush with an associated one of the lateral sides 18 of the sole 14 when the eraser 38 is fully inserted into the channel 24. Similarly, an exposed face 50 of the housing 28 is flush with an associated one of the lateral sides 18 of the sole 14 when the housing 28 is fully inserted into the channel 24. The conical receiver 30 extends into the exposed face 50 of the housing 28 allowing the pencil to be sharpened without removing the housing 28 from the channel 28 through the sole 14.

In use, the shoe 16 is worn in conventional fashion. When needed, the pencil may be inserted into the conical receiver 30 of the housing 28 with or without removing the housing 28 from the channel 24. As needed, the eraser 38 may be removed from the channel 24 for use to erase pencil markings or to provide access to the space 46 to remove pencil shavings from the channel 24.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A pencil sharpening footwear device comprising:
an upper;
a sole coupled to said upper wherein said upper and said sole define a shoe configured for wearing on a human foot, said sole having a pair of lateral side extending between a front of said sole and a back of said sole, said sole being structured to include a channel extending through said sole between said lateral sides;
a housing, said housing being insertable into said channel, said housing being structured to include a conical receiver and a slot extending along said conical receiver; and
a blade coupled to said housing, said blade extending along said slot in said conical receiver wherein said blade is configured to sharpen a pencil inserted into said conical receiver.

2. The device of claim 1, further comprising said channel being positioned between a middle of said sole and said back of said sole wherein said channel is configured for positioning under a heel of the human foot inserted into said shoe.

3. The device of claim 1, further comprising an eraser, said eraser being insertable into said channel, said eraser having an outer peripheral shape complementary to said channel such that said eraser is retained within said channel when said eraser is inserted into said channel.

4. The device of claim 3, further comprising a proximal surface of said eraser relative to said housing being positioned in spaced relationship to an innermost edge of said housing when said housing and said eraser are both positioned fully within said channel wherein a space therebetween is configured for permitting insertion of a finger into said channel to facilitate removal of said housing and said eraser from said channel.

5. The device of claim 3, further comprising an exposed surface of said eraser being flush with an associated one of said lateral sides of said sole when said eraser is fully inserted into said channel.

6. The device of claim 1, further comprising an exposed face of said housing being flush with an associated one of said lateral sides of said sole when said housing is fully inserted into said channel.

7. The device of claim 6, further comprising said conical receiver extending into said exposed face of said housing.

8. A pencil sharpening footwear device comprising:
an upper;
a sole coupled to said upper wherein said upper and said sole define a shoe configured for wearing on a human foot, said sole having a pair of lateral side extending between a front of said sole and a back of said sole, said sole being structured to include a channel extending through said sole between said lateral sides, said channel being positioned between a middle of said sole and said back of said sole wherein said channel is configured to be positioned under a heel of the human foot inserted into said shoe;
a housing, said housing being insertable into said channel, said housing being structured to include a conical receiver and a slot extending along said conical receiver;
a blade coupled to said housing, said blade extending along said slot in said conical receiver wherein said blade is configured to sharpen a pencil inserted into said conical receiver;
an eraser, said eraser being insertable into said channel, said eraser having an outer peripheral shape complementary to said channel such that said eraser is retained within said channel when said eraser is inserted into said channel;
a proximal surface of said eraser relative to said housing being positioned in spaced relationship to an innermost edge of said housing when said housing and said eraser are both positioned fully within said channel wherein a space therebetween is configured for permitting insertion of a finger into said channel to facilitate removal of said housing and said eraser from said channel;
an exposed surface of said eraser being flush with an associated one of said lateral sides of said sole when said eraser is fully inserted into said channel; and
an exposed face of said housing being flush with an associated one of said lateral sides of said sole when said housing is fully inserted into said channel, said conical receiver extending into said exposed face of said housing.
